(19) United States
(12) Patent Application Publication
(10) Pub. No.: US 2008/0152489 A1
(43) Pub. Date: Jun. 26, 2008

(54) Heat dissipating fan with wire retaining device

(75) Inventors: Horng Alex, Kaohsiung (TW); Fang Mei-Chih, Kaohsiung (TW)

Correspondence Address: Joe McKinney Muncy, PO Box 1364, Fairfax, VA, 22038-1364, US

(73) Assignee: Sunonwealth Electric Machine Industry Co., Ltd.

(21) Appl. No.: 11/709,162

(22) Filed: Feb. 22, 2007

(30) Foreign Application Priority Data
Dec. 26, 2006 (TW) 95148972

(51) Int. Cl. F03D 11/04

(52) U.S. Cl. 415/213.1

(57) ABSTRACT

A heat dissipating fan with a wire retaining device includes a housing having a first end wall and a second end wall respectively on two ends thereof. A peripheral wall is formed between the first and second end walls. At least one of the first and second end walls includes a slot extending from a side through the other side thereof. A restraining member includes a first end fixed to the peripheral wall and a second, free end not connected to the peripheral wall, forming a guide opening between the free end of the restraining member and the peripheral wall. A conductive wire is insertable through the guide opening into a space between the restraining member and the peripheral wall.

### BACKGROUND OF THE INVENTION

1. Field of the Invention

The present invention relates to a heat dissipating fan and, more particularly, to a heating dissipating fan with a wire retaining device to prevent conductive wires extending outward from a housing of the heating dissipating fan from being disengaged due to pulling.

2. Description of Related Art

Taiwan Utility Model Application No. 87216621 discloses a heat dissipating fan housing. As illustrated in FIG. 1, the housing 80 includes a vent 81 in which a plurality of connecting rods 82 are provided for supporting a base 83. The base 83 includes a hole 84 for coupling with a stator seat 85. The housing 80 includes a notch 86 in communication with the vent 81. A restraining member 87 is provided on an end of the notch 86. When the stator seat 85 is coupled to the hole 84 of the base 83, wires 851 of the stator base 85 are extended outward via the notch 86 of the housing 80 and retained in place by the restraining member 87. Thus, the wires 851 are prevented from being disengaged from joints on the stator base 85.

FIG. 2 illustrates another conventional heat dissipating fan including a housing 90 having a horizontal guide groove 91 in a bottom thereof for receiving a conductive wire 94. A longitudinal guide groove 92 extends from an end of the horizontal guide groove 91 and tapers upward in section. A retaining member 93 is inserted into the horizontal guide groove 91 for pressing and, thus, positioning the conductive wire 94 in the horizontal guide groove 91. The conductive wire 94 is then bent downward and extended outward via the longitudinal guide groove 92.

In the wire retaining device shown in FIG. 1, the wires 851 are only retained in place by the restraining member 87 on the end of the notch 86. When the wires 851 are pulled outward by an external force, the wires 851 are liable to move out of the retraining member 87 via an opening between the restraining member 87 and the housing 80. Namely, the retaining effect of the wire retaining device is unsatisfactory, and the wires 851 may be disengaged from the joints by pulling.

In the wire retaining device shown in FIG. 2, although the retaining member 93 provides a better retaining effect for the conductive wire 94, additional cost is required for manufacturing the retaining member 93 while an additional procedure is required for assembling the retaining member 93 into the horizontal guide groove 91, leading to inconvenience to assembly and increased costs.

### OBJECTS OF THE INVENTION

An object of the present invention is to provide a heat dissipating fan with a wire retaining device including a restraining member on a peripheral wall between two end walls of the housing for reliably retaining the conductive wire in place, thereby preventing the conductive wire from being disengaged from joints due to pulling.

Another object of the present invention is to provide a heat dissipating fan with a wire retaining device including a restraining member directly formed on a peripheral wall between two end walls of the housing for reducing the manufacturing cost for the heat dissipating fan.

### SUMMARY OF THE INVENTION

In accordance with an aspect of the present invention, a heat dissipating fan with a wire retaining device includes a housing including a first end wall and a second end wall respectively on two ends thereof. A peripheral wall is formed between the first and second end walls. At least one of the first and second end walls includes a slot extending from a side through the other side thereof. A restraining member includes a first end fixed to the peripheral wall and a second, free end not connected to the peripheral wall, forming a guide opening between the free end of the restraining member and the peripheral wall and forming a space between the restraining member and the peripheral wall. The space is adapted for receiving a conductive wire insertable through the guide opening into the space.

Preferably, the restraining member is located below and aligned with the slot.

Preferably, the slot includes two lateral sides extending along two axial lines parallel to an axial axis of the housing, and wherein the guide opening between the free end of the straining member and the peripheral wall is located outside an area between the axial lines.

Preferably, the guide opening between the free end of the straining member and the peripheral wall has a width smaller than a thickness of the conductive wire.

Preferably, the restraining member is spaced from the first and second end walls of the housing.

In accordance with another aspect of the present invention, a heat dissipating fan with a wire retaining device includes a housing including a first end wall and a second end wall respectively on two ends thereof. A peripheral wall is formed between the first and second end walls. At least one of the first and second end walls includes a slot extending from a side through the other side thereof. The heat dissipating fan further includes a plurality of restraining members each including a first end fixed to the peripheral wall and a second, free end not connected to the peripheral wall, forming a guide opening between the free end of each restraining member and the peripheral wall and forming a space between each restraining member and the peripheral wall, wherein the space is adapted for receiving a conductive wire insertable through the guide opening into the space.

Preferably, the restraining members are spaced and aligned in a vertical direction.

Preferably, the slot includes two lateral sides extending along two axial lines parallel to an axial axis of the housing, and the guide opening between the free end of each straining member and the peripheral wall is located outside an area between the axial lines.

Alternatively, the restraining members are not aligned with each other.

Preferably, the guide openings of the restraining members face opposite directions.

Preferably, the guide opening between the free end of each straining member and the peripheral wall has a width smaller than a thickness of the conductive wire.

Preferably, the restraining members are spaced from the first and second end walls of the housing.

In accordance with a third aspect of the present invention, a heat dissipating fan with a wire retaining device includes a housing including a first end wall and a second end wall respectively on two ends thereof. A peripheral wall is formed between the first and second end walls. A restraining member includes a first end fixed to the peripheral wall and a second, free end not connected to the peripheral wall, forming a guide opening between the free end of the restraining member and the peripheral wall and forming a space between the restraining member and the peripheral wall. The space is adapted for receiving a conductive wire insertable through the guide opening into the space.

Preferably, one of the first and second end walls includes a slot extending from a side through the other side thereof.

Preferably, the restraining member is located below and aligned with the slot.

Preferably, the guide opening between the free end of the straining member and the peripheral wall has a width smaller than a thickness of the conductive wire.

Preferably, the other end wall includes a slot extending from a side through another side thereof.

Preferably, the restraining member is spaced from the first and second end walls of the housing.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of a conventional heat dissipating fan with a wire retaining device;

FIG. 2 is a partial perspective view of another conventional heat dissipating fan with a wire retaining device;

FIG. 3 is a perspective view of a first embodiment of a heat dissipating fan with a wire retaining device in accordance with the present invention;

FIG. 4 is a side view of the heat dissipating fan in FIG. 3;

FIG. 5 is a sectional view taken along plan 5-5 in FIG. 4;

FIG. 6 is a perspective view of a second embodiment of the heat dissipating fan with a retaining device in accordance with the present invention;

FIG. 7 is a side view of the heat dissipating fan in FIG. 6; and

FIG. 8 is a sectional view taken along plane 8-8 in FIG. 7.

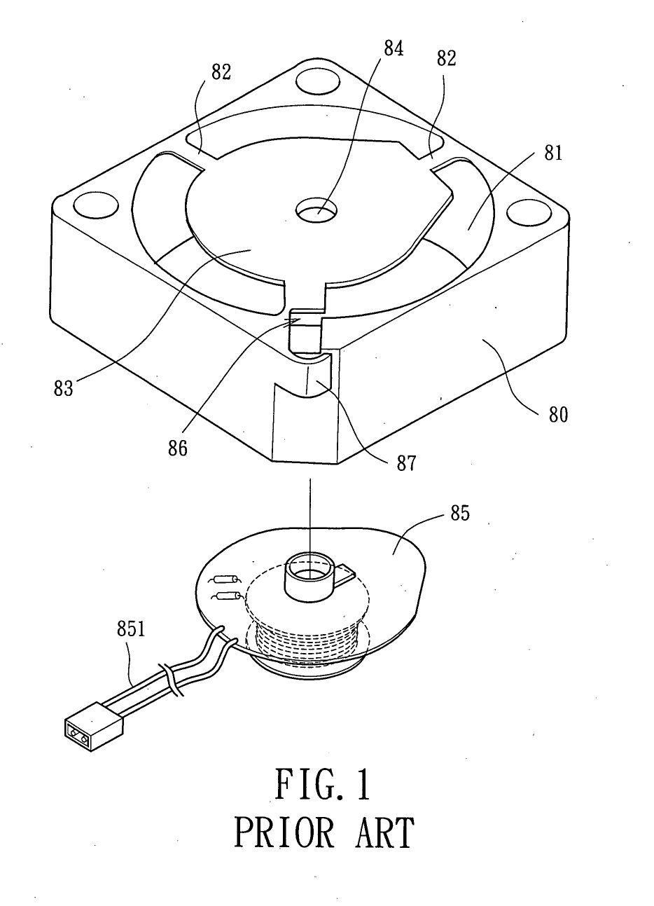

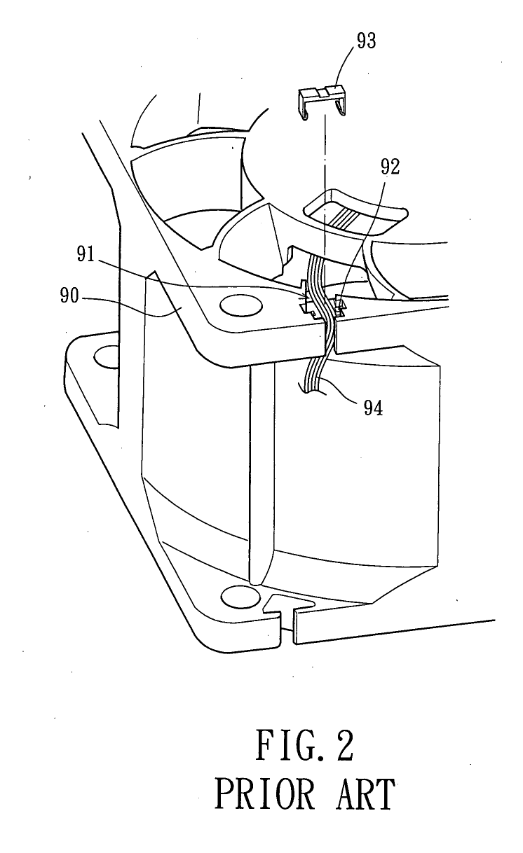

### DETAILED DESCRIPTION OF THE PREFERRED EMBODIMENTS

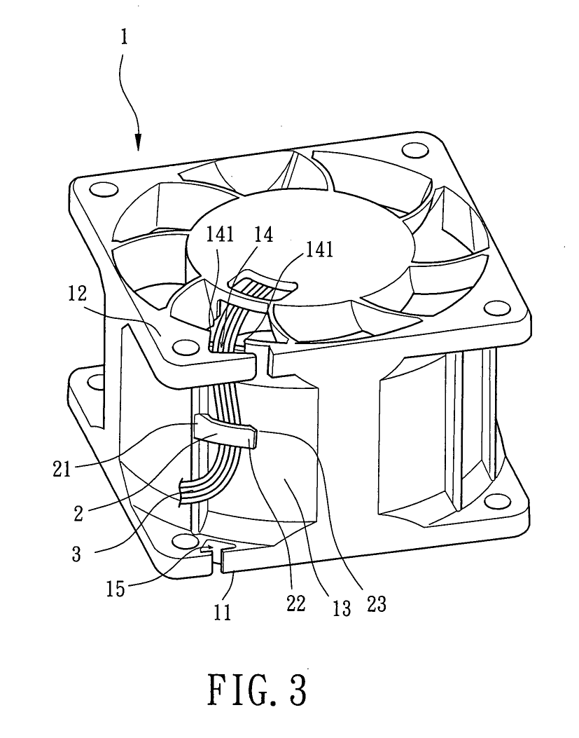

Referring to FIG. 3, a first embodiment of a heat dissipating fan with a wire retaining device in accordance with the present invention includes a housing 1 having a first end wall 11 and a second end wall 12 respectively on two ends thereof. A peripheral wall 13 is formed between the first and second end walls 11 and 12. A slot 14 extends from a side through the other side of the second end wall 12. One or more conductive wires 3 are extended from the side of the second end wall 12 through the other side of the second end wall 12 to the peripheral wall 13 via the slot 14. The slot 14 includes two lateral sides 141 for restraining movement of the conductive wire 3.

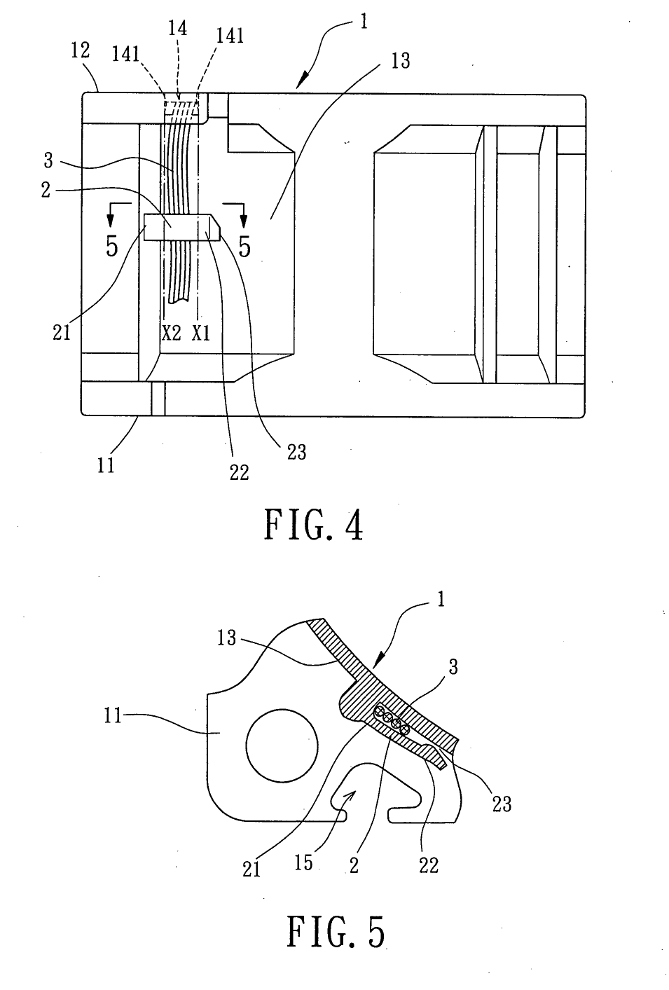

With reference to FIGS. 3-5, at least one restraining member 2 extends outward from the peripheral wall 13 and is located below and aligned with the slot 14. In the embodiment shown, the restraining member 2 is spaced from the first and second end walls 11 and 12. Specifically, an end 21 of the restraining member 2 is connected to the peripheral wall 13. The other end of the restraining member 2 is a free end 22 not connected to the peripheral wall 13, forming a guide opening 23 between the free end 22 of the restraining member 2 and the peripheral wall 13. Thus, the conductive wire 3 can be inserted into a space between the peripheral wall 13 and the restraining member 2 via the guide opening 23. Preferably, the conductive wire 3 is restrained by the restraining member 2 to be in contact with the peripheral wall 13. In the embodiment shown, the width of the guide opening 23 is smaller than the thickness of the conductive wire 3. The lateral sides 141 of the slot 14 in the second end wall 12 respectively extend in two axial lines X1 and X2 parallel to an axial axis of the housing 1. Preferably, the guide opening 23 between the free end 22 of the restraining member 2 and the peripheral wall 13 is located outside an area between the axial lines X1 and X2. Thus, when the conductive wire 3 is pulled by an external force, the lateral sides 141 of the slot 14 in the second end wall 12 restrain movement of the conductive wire 3 such that the conductive wire 3 cannot move out of the space between the restraining member 2 and the peripheral wall 13 via the guide opening 23 of the restraining member 2. Furthermore, the restraining member 2 withstands the pulling force and, thus, avoids the conductive wire 3 from disengaging from joints (not shown). The first end wall 11 may include a slot 15 extending from a side through the other side of the first end wall 11. Preferably, the slot 15 is located below and aligned with the restraining member 2.

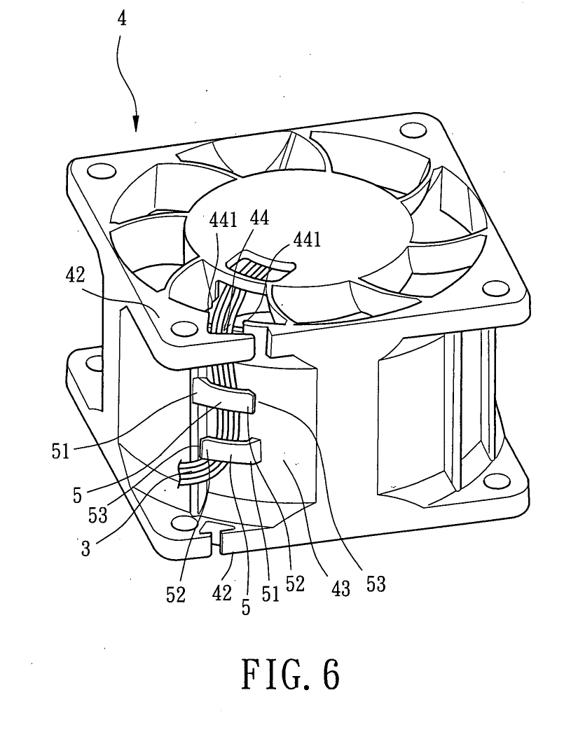

FIG. 6 illustrates a second embodiment of the heat dissipating fan with a wire retaining device in accordance with the present invention. In the embodiment shown, the heat dissipating fan includes a housing 4 having a first end wall 41 and a second end wall 42 respectively on two ends thereof. A peripheral wall 43 is formed between the first and second end walls 41 and 42. A slot 44 extends from a side through the other side of the second end wall 42.

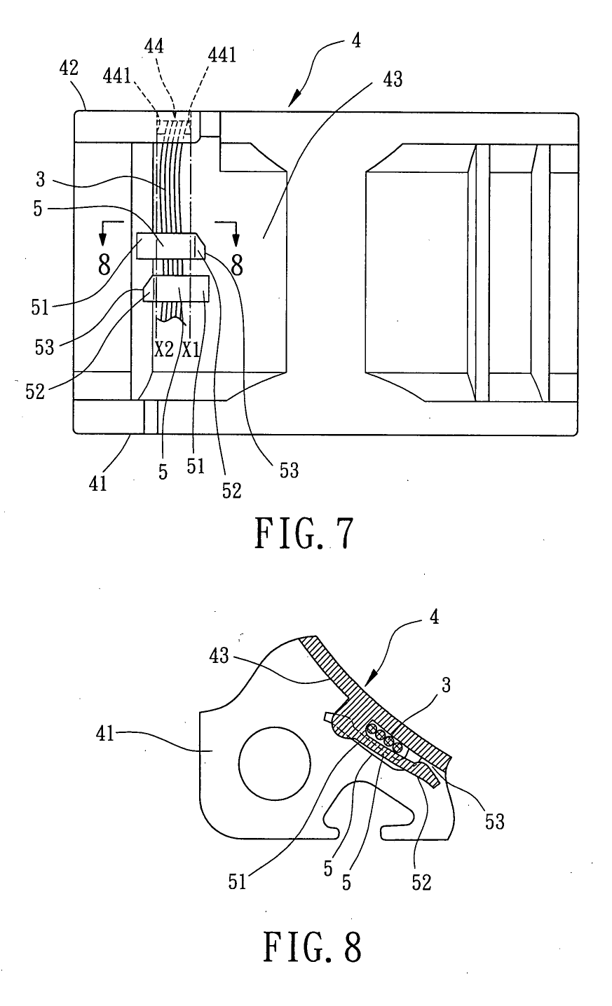

With reference to FIGS. 6-8, two restraining members 5 extend outward from the peripheral wall 43 and spaced and aligned in a vertical direction. Alternatively, the restraining members 5 are not aligned with each other. In the embodiment shown, the restraining members 5 are located below and aligned with the slot 14. Furthermore, the restraining members 5 are spaced from the first and second end walls 41 and 42. Specifically, an end 51 of each restraining member 5 is connected to the peripheral wall 43. The other end of each restraining member 5 is a free end 52 not connected to the peripheral wall 43, forming a guide opening 53 between the free end 52 of the restraining member 5 and the peripheral wall 43. Thus, the conductive wire 3 can be inserted into a space between the peripheral wall 43 and each restraining member 5 via the guide opening 53. In the embodiment shown, the width of the guide opening 53 of each restraining member 5 is smaller than the thickness of the conductive wire 3. Furthermore, the guide openings 53 respectively of the restraining members 5 face opposite directions. Two lateral sides 441 of the slot 44 in the second end wall 42 respectively extend in two axial lines X1 and X2 parallel to an axial axis of the housing 4. Preferably, the guide opening 53 of each restraining member 5 is located outside an area between the axial lines X1 and X2. Thus, when the conductive wire 3 is pulled by an external force, the lateral sides 441 of the slot 44 in the second end wall 42 restrain movement of the conductive wire 3 such that the conductive wire 3 cannot move out of the spaces between the respective restraining members 5 and the peripheral wall 43 via the respective guide openings 53 of the respective restraining members 5. Furthermore, the restraining members 5 withstand the pulling force and, thus, avoid the conductive wire 3 from disengaging from joints (not shown). The first end wall 41 may include a slot 45 extending from a side through the other side of the first end wall 41. Preferably, the slot 45 is located below and aligned with the restraining members 5.

As apparent from the foregoing, by providing at least one restraining member on the peripheral wall of the housing, the conductive wire is prevented from being disengaged from the joints and from being pulled off. The disengagement prevention effect is further enhanced by arranging the guide opening(s) in an area outside the axial lines X1 and X2 along which two lateral sides of the slot extend. The disengagement prevention effect is further enhanced by providing two guiding openings facing opposite directions. Furthermore, the structure of the heat dissipating fan housing in accordance with the present invention is simple and, thus, easy to assemble, allowing a reduction in the manufacturing cost.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A heat dissipating fan with a wire retaining device, comprising:
a housing including a first end wall and a second end wall respectively on two ends thereof, a peripheral wall being formed between the first and second end walls, at least one of the first and second end walls including a slot extending from a side through another side thereof; and
a restraining member including a first end fixed to the peripheral wall and a second, free end not connected to the peripheral wall, forming a guide opening between the free end of the restraining member and the peripheral wall and forming a space between the restraining member and the peripheral wall, with the space being adapted for receiving a conductive wire insertable through the guide opening into the space.

2. The heat dissipating fan with a wire retaining device as claimed in claim 1, wherein the restraining member is located below and aligned with the slot.

3. The heat dissipating fan with a wire retaining device as claimed in claim 1, wherein the slot includes two lateral sides extending along two axial lines parallel to an axial axis of the housing, and wherein the guide opening between the free end of the straining member and the peripheral wall is located outside an area between the axial lines.

4. The heat dissipating fan with a wire retaining device as claimed in claim 1, wherein the guide opening between the free end of the straining member and the peripheral wall has a width smaller than a thickness of the conductive wire.

5. The heat dissipating fan with a wire retaining device as claimed in claim 1, wherein the restraining member is spaced from the first and second end walls of the housing.

6. A heat dissipating fan with a wire retaining device, comprising:
a housing including a first end wall and a second end wall respectively on two ends thereof, a peripheral wall being formed between the first and second end walls, at least one of the first and second end walls including a slot extending from a side through another side thereof; and
a plurality of restraining members each including a first end fixed to the peripheral wall and a second, free end not connected to the peripheral wall, forming a guide opening between the free end of each said restraining member and the peripheral wall and forming a space between each said restraining member and the peripheral wall, with the space being adapted for receiving a conductive wire insertable through the guide opening into the space.

7. The heat dissipating fan with a wire retaining device as claimed in claim 6, wherein the restraining members are spaced and aligned in a vertical direction.

8. The heat dissipating fan with a wire retaining device as claimed in claim 6, wherein the slot includes two lateral sides extending along two axial lines parallel to an axial axis of the housing, and wherein the guide opening between the free end of each said straining member and the peripheral wall is located outside an area between the axial lines.

9. The heat dissipating fan with a wire retaining device as claimed in claim 6, wherein the restraining members are not aligned with each other.

10. The heat dissipating fan with a wire retaining device as claimed in claim 6, wherein the guide openings of the restraining members face opposite directions.

11. The heat dissipating fan with a wire retaining device as claimed in claim 6, wherein the guide opening between the free end of each said straining member and the peripheral wall has a width smaller than a thickness of the conductive wire.

12. The heat dissipating fan with a wire retaining device as claimed in claim 6, wherein the restraining members are spaced from the first and second end walls of the housing.

13. A heat dissipating fan with a wire retaining device, comprising:
a housing including a first end wall and a second end wall respectively on two ends thereof, a peripheral wall being formed between the first and second end walls; and
a restraining member including a first end fixed to the peripheral wall and a second, free end not connected to the peripheral wall, forming a guide opening between the free end of the restraining member and the peripheral wall and forming a space between the restraining member and the peripheral wall, with the space being adapted for receiving a conductive wire insertable through the guide opening into the space.

14. The heat dissipating fan with a wire retaining device as claimed in claim 13, wherein one of the first and second end walls includes a slot extending from a side through another side thereof.

15. The heat dissipating fan with a wire retaining device as claimed in claim 14, wherein the restraining member is located below and aligned with the slot.

16. The heat dissipating fan with a wire retaining device as claimed in claim 14, wherein the guide opening between the free end of the straining member and the peripheral wall has a width smaller than a thickness of the conductive wire.

17. The heat dissipating fan with a wire retaining device as claimed in claim 14, wherein the other of the first and second end walls includes a slot extending from a side through another side thereof.

18. The heat dissipating fan with a wire retaining device as claimed in claim 12, wherein the restraining member is spaced from the first and second end walls of the housing.
